(19) United States
(12) Patent Application Publication
(10) Pub. No.: US 2019/0146464 A1
(43) Pub. Date: May 16, 2019

(54) MANAGEMENT METHOD FOR OBJECT SUPPLY AND MANAGEMENT SYSTEM USING THEREOF

(71) Applicant: National Tsing Hua University, Hsinchu City (TW)

(72) Inventor: Wei-Chang Yeh, Hsinchu (TW)

(73) Assignee: National Tsing Hua University, Hsinchu City (TW)

(21) Appl. No.: 15/979,390

(22) Filed: May 14, 2018

(30) Foreign Application Priority Data
Nov. 15, 2017 (TW) 106139513

(51) Int. Cl. G05B 19/418

(52) U.S. Cl. CPC G05B 19/41865; G05B 2219/32117

(57) ABSTRACT

A management method for objects supply and a management system using the same are provided. The management method is adapted to an object-supply network model including a start point, an end point, multiple sub-points and multiple sub-routes, and includes following steps: obtaining a plurality of object states and corresponding probability distributions of each supply sub-route and connection relationships among the supply sub-routes; listing a plurality of object supply routes corresponding to each of the object states, and calculating supply route reliability values of the respective object supply routes by a network reliability algorithm; and, managing the input objects and output objects according to the object supply route with the maximum supply route reliability value.

### CROSS-REFERENCE TO RELATED APPLICATION

This application claims the priority benefit of Taiwan application serial no. 106139513, filed on Nov. 15, 2017. The entirety of the above-mentioned patent application is hereby incorporated by reference herein and made a part of this specification.

### BACKGROUND OF THE INVENTION

### 1. Field of the Invention

The invention relates to a management and control technology for factory management, raw material and logistics control, and commodity and object supply chain, and particularly relates to a management method for object supply and a management system using the same.

### 2. Description of Related Art

In management technologies for supply chains of commodities, it is known to adopt a “basic network model” (also referred to as basic network reliability algorithm) to achieve commercial distribution of one type of commodities through controlling transportation and manufacturing costs, so as to properly manage the transportation or management network and avoid waste of transportation and monetary costs. The basic network model is generally formed by various terminals (e.g., commodities/objects) and edges (potentially variable states of commodities/objects and probability distributions associated with the states).

In the known basic network model, the inherent properties of any terminal remain the same from the start point to the end point of a commodity supply network. For example, tap water flows from a reservoir (start point) to the household (end point) through multiple pipes, but the inherent properties of tap water remain the same. Nevertheless, such supply chain of commodities and management technology of commodities only control raw materials and final products of the commodities without considering that half-finished products or relevant parts of the commodities may be prepared by other manufacturers before these materials/commodities are formed into commodities for sale. The costs and yield rates of different manufacturers may differ. In practice, various products may be formed from different commodities or raw materials. For example, two lamps manufactured by Factory A and a lamp base manufactured by Factory B may be assembled at Factory C to form a lighting fixture having one or two lamps (the lighting fixture is not formed by only the lamp or the lamp base). As another example, the substance formed by hydrogen atoms and oxygen atoms may be H₂O or H₂O₂. The known basic network reliability algorithm does not account for variations of terminals (e.g., commodities/objects) and states. For example, the commodities may not be simply made of raw materials but may be formed through combining various half-finished products, and shipping and production of commodities may be adjusted due to different quantities of raw materials, and such circumstances are not factored in and analyzed by the basic network reliability algorithm.

Besides, as the functions of commodities increase, the commodities may need to be manufactured by combining multiple parts manufactured by different manufacturers. Hence, factors such as procurement of parts of the commodities, processing time and yield rates of manufacturers and/or vendors, and the like also need to be taken into consideration. Hence, how to develop a more effective management and control technology for the supply chain of commodities is becoming an issue to work on.

### SUMMARY OF THE INVENTION

One or some exemplary embodiments of the invention provide a management method for object supply and a management system using the same. The method and the system are capable of conducting evaluation and choosing an ideal cost distribution and commodity manufacturing plan for manufacture of commodities and/or transportation of commodities.

A management method for object supply according to an embodiment of the invention is adapted for an object-supply network model including a start point, an end point, multiple sub-points and multiple sub-routes. The management method includes the following: obtaining object states and corresponding probability distributions of each of the supply sub-routes and connection relationships among the supply sub-routes, wherein each of the object states is defined by a plurality of input objects and a corresponding quantity as well as a plurality of output objects and a corresponding quantity; listing a plurality of object supply routes corresponding to each of the object states, and calculating supply route reliability values of the respective object supply routes by a network reliability algorithm, wherein each of the object supply routes starts from the start point and ends at the end point, and each of the object supply routes is formed by at least two of the supply sub-routes; and managing the input objects and the output objects according to the object supply route with the maximum supply route reliability value.

A management system for object supply according to an embodiment of the invention is adapted for an object-supply network model including a start point, an end point, multiple sub-points and multiple sub-routes. The management system includes an input device and a processor. The input device is adapted to obtain object states and corresponding probability distributions of each of the supply sub-routes and connection relationships among the supply sub-routes, wherein each of the object states is defined by a plurality of input objects and a corresponding quantity as well as a plurality of output objects and a corresponding quantity. The processor is coupled to the input device. The processor is adapted to list a plurality of object supply routes corresponding to each of the object states and calculate supply route reliability values of the respective object supply routes by a network reliability algorithm. Each of the object supply routes starts from the start point and ends at the end point, and each of the object supply routes is formed by at least two of the supply sub-routes. The processor manages the input objects and output objects according to the object supply route with the maximum supply route reliability value.

Based on the above, in the management method for object supply and the management system using the same according to the embodiments of the invention, the reliabilities of the supply chains of objects (e.g., commodities) are calculated by combining the concepts of “multiple aggregations” and “heterogeneous aggregations” and the network reliability algorithm, and the reliabilities of the supply chains of objects are adapted as the supply route reliability values to evaluate and choose a cost allocation and commodity manufacturing plan that is optimal for manufacture and/or transportation of commodities. Accordingly, the factory manager or the raw material feeding manager may be timely informed of the supply conditions of the objects (commodities), adjust the suppliers of raw materials, and manage the allocation of facility and human resources in the factory.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a management system for object supply according to an embodiment of the invention.

FIG. 2 is a schematic view illustrating an object supply network model handled by a management system for object supply according to an embodiment of the invention.

FIG. 3 is a flowchart illustrating a management method for object supply according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

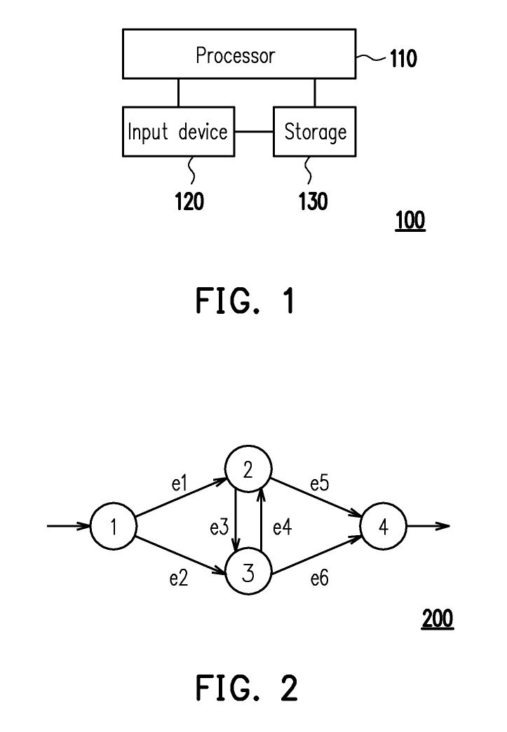

FIG. 1 is a schematic view illustrating a management system 100 for object supply according to an embodiment of the invention. Referring to FIG. 1, the management system 100 for object supply mainly includes a processor 110 and an input device 120. The processor 110 is coupled to the input device 120. The management system 100 for object supply may further include a storage 130 coupled to the input device 120 and the processor 110.

The input device 120 includes an input device such as a keyboard, a mouse, a touch panel, or the like. The input device 120 is adapted to obtain various infonnation input by the user into an object supply network model. The object supply network model may include a start point, an end point, sub-points, and a plurality of supply sub-routes as edges. Hence, the various information of the object supply network model may include a distribution value of each of the supply sub-routes, state distributions respectively corresponding to the distribution values, connection relationships among the supply sub-routes, object states of a plurality of input objects and a plurality of output objects, and probability distributions of the respective object states. The start point corresponds to the input objects, the end point corresponds to the output objects, and the sub-points correspond to half-finished products of the output objects.

The storage 130 may be a random access memory (RAM), for example, and store the various information for the object supply network model obtained through the input device 120. The storage 130 may also store an algorithm, a modularized program, or a processing procedure relating to calculation in the embodiment of the invention for the processor 110 to access and execute.

The processor 110 may be a central processing unit (CPU) or other programmable general-purpose or specific-purpose microprocessors, digital signal processors (DSP), programmable controllers, application specific integrated circuits (ASIC), other devices, or a combination thereof

FIG. 2 is a schematic view illustrating an object supply network model handled by a management system for object supply according to an embodiment of the invention. Referring to FIG. 2, the object supply network model is described with reference to a basic network model. Basic network models may be mainly classified into binary-state networks (BN), multi-state flow networks (MFN), and multi-commodity multi-state flow networks (MMFN). Components in BN have only two states, i.e., succeed or fail. Components in MFN may have a plurality of states. Components in MMFN inherently exhibit a plurality of variations, and variations of each component correspond to different states. The object supply network model is extensively derived from the MMFN. The object supply network model includes a plurality of points and a plurality of edges. In the embodiment, the points are considered as changes of states of products. For example, objects may turn from raw materials to half-finished products, and then to products. In other words, each of the points may be also be considered as a supplier of a raw material, a half-finished product, or a product. Directions of feeding materials and producing objects of the suppliers and object producing reliabilities of the suppliers (also referred to as supply route reliabilities) may be represented by specific points and edges whose start points are the specific points. The respective edges in the object supply network model are adapted to represent the supply sub-routes of the respective objects (raw materials, half-finished products, or products).

An object supply network model 200 in FIG. 2 includes four points and six edges. A point N1 is the start point, a point N4 is the end point, and points N2 and N3 are sub-points. The respective edges (supply sub-routes) are directional. In addition, the edges are connected through the points. For example, the direction of an edge e1 is from the point N1 to the point N2, the direction of an edge e3 is from the point N2 to the point N3, and the edge e1 and the edge e3 are connected with each other.

The object supply network model 200 represents a process of manufacturing one or more products, where a plurality of raw materials are manufactured into half-finished products, and the half-finished products are manufactured into end products. The respective points represent object states, such as the numbers of hours/days elapsed during manufacturing processes of objects (e.g., raw materials or half-finished products), the quantities of objects, or the like. The start point (point N1) corresponds to an object as the raw material, and the end point (point N4) corresponds to an object as the final product. The respective sub-points (points N2, N3) may correspond to various object states (e.g., raw materials, half-finished products, or products). The respective edges (supply sub-routes) represents actions or measures taken after the objects (e.g., raw materials or half-finished products) are produced, such as shipment to another manufacturer for assembling or retooling. In addition, each of the edges has a plurality of distribution values and a plurality of state distributions corresponding to the distribution values in a one-to-one manner. The distribution values represent budgets required for taking actions or measures for the objects represented by the supply sub-routes, for example, and the state distributions represent probability distributions of making change to the object states with the corresponding budgets, for example. The description “making change to the object state” refers to, for example, forming a half-finished product by processing a raw material, or forming a product by assembling a plurality of half-finished products, for example.

In addition, the object supply network model 200 is also infonned of the object states of the input objects and the output objects and the probability distributions corresponding to the respective object states. In the embodiment, the object states and the corresponding probability distributions may be as shown in Table 1.

TABLE 1

| | | | Probability |
|---|---|---|---|
| Object State | Input Object | Output Object | Distribution |
| 1 | 0 | 0 | 0.05 |
| 2 | X | X | 0.1 |
| 3 | 3A + 2B | C + 2D | 0.2 |
| 4 | 3A + 2B | 2C + D | 0.3 |
| 5 | A + C | B + D | 0.2 |
| 6 | 2B + C | A + D + E | 0.15 |

In the embodiment, one state distribution corresponding to one object state includes a plurality of input objects, corresponding output objects, and corresponding probability values. In addition, a sum of all the probability values of object states 1 to 6 in the embodiment is 1. The object states may be defined based on a plurality of input objects and a corresponding quantity as well as a plurality of output objects and a corresponding quantity. The object states of each of the supply sub-routes and the probability distribution of each of the object states include the distribution values of each of the supply sub-routes and the state distributions respectively corresponding to the distribution values. In the embodiment, the distribution values of the supply sub-routes and the connection relationships among the supply sub-routes relate to probability values or probability distributions of finishing commodities of raw material suppliers or half-finished product related to the objects, such as efficiencies and yield rates of object of different manufacturers when the same number of hours or days is given. In some embodiments, the probability values of finishing commodities may also be defined by one or a combination of supply times, supply costs, and shipping costs of the raw material suppliers or the half-finished product suppliers. Nevertheless, the embodiments of the invention are not limited thereto.

Each of the supply sub-routes may have a plurality of distribution values representing actions or measures taken for the objects represented by the supply sub-route, and there may be multiple choices in terms of variations of the objects. For example, the object state 1 represents that the input object is 0 and the output object is 0, and the probability distribution of the object state is 0.05. The object state 2 represents object X whose input object and output object are both one unit, and the probability distribution of the object state is 0.1. The object state3 represents one unit of object C and two units of object D formed by three units of object A and two units of object B. The probability distribution of the object state is 0.2. The object state 4 represents one unit of object C and two units of object D formed by three units of object A and two units of object B. The probability distribution of the object state is 0.3. Following the same principle, the commodities may be formed through a plurality of different manufacturing procedures through different points (variations of object states) and different edges (supply sub-routes), which demonstrates the concept of “multiple aggregations (of commodities)” according to the embodiments of the invention. The concept of “multiple aggregations (of commodities)” may also be referred to as “heterogeneous aggregations (of commodities)”, as commodities of different types or models may be manufactured by adopting different types of raw materials according to the embodiments of the invention.

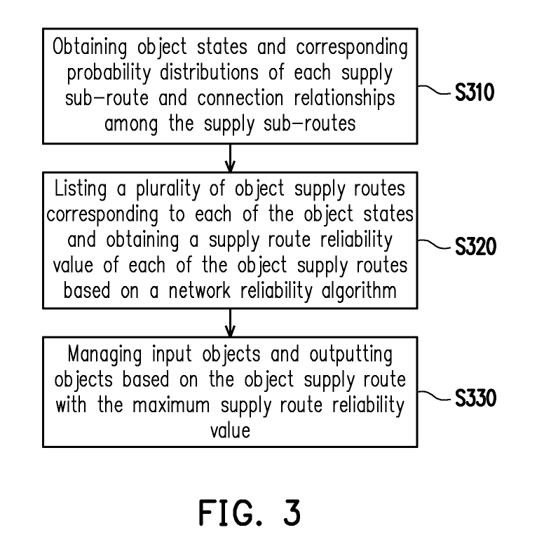

FIG. 3 is a flowchart illustrating a management method for object supply according to an embodiment of the invention. Referring to FIGS. 2 and 3, at Step S320, the various information relating to the object supply network model 200 input by the user is received through the input device 120. The various information may include the object states and corresponding probability distributions of each of the supply sub-routes and the connection relationships among the supply sub-routes. The connection relationships among the respective supply sub-routes include, for example, a direction of a supply sub-route stored in a specific data structure and information of other two edges connected to the initial point and the final point of the supply sub-route. Details of the respective object states and the corresponding probability distributions are as described in the foregoing.

At Step S320, the processor 110 lists the object supply routes corresponding to each of the object states, and calculates the supply route reliability value of each of the object supply routes by a network reliability algorithm. Each of the object supply routes starts from the start point (point N1 in FIG. 2), and ends at the end point (point N4 in FIG. 2). In addition, each of the object supply routes is formed by at least two of the supply sub-routes. For example, the processor 110 may list different object supply routes for one of the object states, such as an object supply route 1 from the edge e1 to the edge e3 and then to the edge e 6, an object supply route 2 from the edge e1 to the edge e3, then to the edge e4 and then to the edge e5, an object supply route 3 from the edge e2 to the edge e4 and then to the edge e5, and an object supply route 4 from the edge e2 to the edge e4, then to the edge e3 and then to the edge e6.

Then, the processor 110 may calculate the supply route reliability value of each of the object supply routes 1 to 4 based on the network reliability algorithm and the respective input values. The supply route reliability value includes tuples in a number equal to the number of edges in the object supply network model 200. Each of the tuples corresponds to any one of a plurality of assignment values of each edge. If a value of any one tuple is increased to the next-higher assignment value of the corresponding edge, a total value of all of the tuples in the supply route reliability value may exceed an assignment upper bound of the object network model. In brief, one assignment value is respectively selected from the assignment values of each edge to form a vector. If any one tuple in the vector is replaced with an assignment value next-higher than the current value in the corresponding edge, and the total value of all of the tuples in the vector exceeds the assignment upper bound of the project network model 200, then the vector is a vector corresponding to the supply route reliability value. After the vectors are obtained, the vectors may be adopted to calculate the supply route reliability values respectively corresponding to the object supply routes 1 to 4. In the embodiment, the branch-and-bound technique is adopted as the method for enumerating critical value assignment vectors. Nevertheless, other algorithms that may render identical or similar effects may also be adopted, such as the method of exhaustion, which performs more poorly in time complexity but is more intuitive in design.

When calculating the supply route reliability values of the respective object supply routes, the processor may check the respective object supply routes. When the object supply route includes the supply sub-routes in different directions at the same time, the processor may remove the object supply route without calculating the corresponding supply route reliability value. For example, the object supply routes 2 and 4 both pass through the edges e3 and e4 having the same terminals (terminals 2 and 3) but in different directions, so the processor may remove the object supply routes 2 and 4 without calculating the corresponding supply route reliability values. This is because, based on various reliability algorithms, the supply route reliability values of the object supply routes 2 and 4 are expected to be lower than those of the object supply routes 1 and 3 as the edges e3 and e4 in the object supply routes 2 and 4 may consume unnecessary transportation costs. Therefore, the supply route reliability values of the object supply routes 2 and 4 may be omitted.

At Step S330, the processor 110 may manage the input objects and the output objects according to the object supply route with the maximum supply route reliability value. For example, the processor 110 may display the object supply route corresponding to the maximum supply route reliability value on a display to inform the factory manager or the raw material feeding manager of the optimal object supply route, so as to timely adjust the types and quantities of the input objects and the output objects, the supply conditions of the objects (commodities), and/or the like. Alternatively, in an automated factory or raw material control system, the processor 110 may control the types and quantities of the input objects or output objects, adjust or replace the raw material suppliers or half-finished product suppliers, or even manage the facility and human resource allocations in the factory directly or indirectly via other control systems, so as to minimize the manufacturing cost of commodities.

When informed of recent shipment conditions of the suppliers, the processor 110 of the embodiment may also convert the shipment conditions into the distribution values of each of the supply sub-routes of the embodiment, the state distributions corresponding to the distribution values, and the connection relationships among the supply sub-routes. Hence, the processor 110 may adjust the distribution values of each of the supply sub-routes, the state distributions respectively corresponding to the distribution values, and the connection relationships among the supply sub-routes, and recalculate the supply route reliability values of the respective object supply routes. As a consequence, the processor 110, the factory manager, or the raw material feeding manager may manage and adjust the input objects and the output objects based on the object supply route corresponding to the maximum supply path reliability value.

In view of the foregoing, in the management method for object supply and the management system using the same according to the embodiments of the invention, the reliabilities of the supply chains of objects (e.g., commodities) are calculated by combining the concepts of “multiple aggregations” and “heterogeneous aggregations” and the network reliability algorithm, and the reliabilities of the supply chains of objects are adapted as the supply route reliability values to evaluate and choose a cost allocation and commodity manufacturing plan that is optimal for manufacture and/or transportation of commodities. Accordingly, the factory manager or the raw material feeding manager may be timely informed of the supply conditions of the objects (commodities), adjust the suppliers of raw materials, and manage the allocation of facility and human resources in the factory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A management method for object supply, adapted for an object supply network comprising a start point, an end point, sub-points, and a plurality of supply sub-routes, the method comprising:
obtaining object states and corresponding probability distributions of each of the supply sub-routes and connection relationships among the supply sub-routes, wherein each of the object states is defined by a plurality of input objects and a corresponding quantity as well as a plurality of output objects and a corresponding quantity;
listing a plurality of object supply routes corresponding to each of the object states, and calculating supply route reliability values of the respective object supply routes by a network reliability algorithm, wherein each of the object supply routes starts from the start point and ends at the end point, and each of the object supply routes is formed by at least two of the supply sub-routes; and
managing the input objects and the output objects according to the object supply route with the maximum supply route reliability value.

2. The management method as claimed in claim 1, wherein the object states of each of the supply sub-routes and the probability distributions of the respective object states comprise distribution values of each of the supply sub-routes and state distributions respectively corresponding to the distribution values, and the distribution values of the supply sub-routes and the connection relationships among the supply sub-routes relate to probability values of finishing commodities of raw material suppliers or half-finished product suppliers of the output objects.

3. The management method as claimed in claim 2, wherein the probability value of finishing commodities is determined by one or a combination of a supply time, a supply cost, and a shipping cost of the raw material supplier or the half-finished supplier.

4. The management method as claimed in claim 2, further comprising:
adjusting the distribution values of each of the supply sub-routes, the state distributions corresponding to the distribution values, and the connection relationships among the supply sub-routes, recalculating the supply route reliability values of the respective object supply routes, and managing and adjusting the input objects and the output objects based on the object supply route corresponding to the maximum supply route reliability value.

5. The management method as claimed in claim 1, wherein calculating the supply route reliability values of the respective object supply routes comprises:
checking each of the object supply routes, and deleting the object supply route when the object supply route comprises the supply sub-routes in different directions at the same time.

6. The management method as claimed in claim 1, wherein two ends of the supply sub-route are two of the start point, the end point, and the sub-points.

7. A management system for object supply, adapted for an object supply network comprising a start point, an end point, sub-points, and a plurality of supply sub-routes, the system comprising:
an input device, adapted to obtain object states and corresponding probability distributions of each of the supply sub-routes and connection relationships among the supply sub-routes, wherein each of the object states is defined by a plurality of input objects and a corresponding quantity as well as a plurality of output objects and a corresponding quantity; and
a processor, coupled to the input device,
wherein the processor is adapted to list a plurality of object supply routes corresponding to each of the object states and calculate supply route reliability values of the respective object supply routes by a network reliability algorithm, wherein each of the object supply routes starts from the start point and ends at the end point, and each of the object supply routes is formed by at least two of the supply sub-routes, and
the processor manages the input objects and output objects according to the object supply route with the maximum supply route reliability value.

8. The management system as claimed in claim 7, wherein the object states of each of the supply sub-routes and the probability distributions of the respective object states comprise distribution values of each of the supply sub-routes and state distributions respectively corresponding to the distribution values, and the distribution values of the supply sub-routes and the connection relationships among the supply sub-routes relate to probability values of finishing commodities of raw material suppliers or half-finished product suppliers of the output objects.

9. The management system as claimed in claim 8, wherein the probability value of finishing commodities is determined by one or a combination of a supply time, a supply cost, and a shipping cost of the raw material supplier or the half-finished supplier.

10. The management system as claimed in claim 8, wherein the processor adjusts the distribution values of each of the supply sub-routes, the state distributions corresponding to the distribution values, and the connection relationships among the supply sub-routes, recalculates the supply route reliability values of the respective object supply routes, and manages and adjusts the input objects and the output objects based on the object supply route corresponding to the maximum supply route reliability value.

11. The management system as claimed in claim 8, wherein the processor checks each of the object supply routes when calculating the supply route reliability value of each of the object supply routes, and deletes the object supply route when the object supply route comprises the supply sub-routes in different directions at the same time.

12. The management system as claimed in claim 8, wherein two ends of the supply sub-route are two of the start point, the end point, and the sub-points.
